(19) United States
(12) Patent Application Publication
(10) Pub. No.: US 2014/0258328 A1
(43) Pub. Date: Sep. 11, 2014

(54) SYSTEM AND METHOD FOR VISUAL DETERMINATION OF THE CORRELATION BETWEEN A MULTIMEDIA CONTENT ELEMENT AND A PLURALITY OF KEYWORDS

(71) Applicant: Cortica, Ltd., Ramat Gan (IL)

(72) Inventors: Igal Raichelgauz, New-York, NY (US); Karina Odinaev, New-York, NY (US); Yehoshua Y. Zeevi, Haifa (IL)

(73) Assignee: CORTICA, LTD., RAMAT GAN (IL)

(21) Appl. No.: 14/267,990

(22) Filed: May 2, 2014

Related U.S. Application Data
(63) Continuation-in-part of application No. 13/624,397, filed on Sep. 21, 2012.
Application No. 13/624,397 is a continuation-in-part of application No. 13/344,400, filed on Jan. 5, 2012.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
Application No. 12/084,150 is a continuation-in-part of application No. 13/770,603, filed on Feb. 19, 2013.
(60) Provisional application No. 61/818,579, filed on May 2, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30038
USPC 707/769

(57) ABSTRACT

A method and system for determining the correlation of at least one keyword to a multimedia content element. The method comprises generating at least one signature to a received multimedia content element; searching for at least one potentially correlative keyword respective of the at least one generated signature; and determining the correlation of each of the at least one keywords to the multimedia content element.

### CROSS-REFERENCE TO RELATED APPLICATIONS

This application claims the benefit of U.S. Provisional Application No. 61/818,579, filed on May 2, 2013, the contents of which are hereby incorporated by reference. This application is also a continuation-in-part (CIP) of U.S. patent application Ser. No. 13/770,603 filed on Feb. 19, 2013, now pending. The Ser. No. 13/770,603 application is a CIP of U.S. patent application Ser. No. 13/624,397 filed on Sep. 21, 2012, now pending. The Ser. No. 13/624,397 application is a CIP of:
(a) U.S. patent application Ser. No. 13/344,400 filed on Jan. 5, 2012, now pending, which is a continuation of U.S. patent application Ser. No. 12/434,221, filed May 1, 2009, now U.S. Pat. No. 8,112,376;
(b) U.S. patent application Ser. No. 12/195,863, filed Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and,
(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005 and Israeli Application No. 173409 filed on 29 Jan. 2006.

All of the applications referenced above are herein incorporated by reference for all that they contain.

### TECHNICAL FIELD

The present invention relates generally to the analysis of multimedia content, and, more specifically to a system for matching a plurality of keywords to the analyzed multimedia content respective of the analysis.

### BACKGROUND

The Internet, also referred to as the worldwide web (WWW), has become a mass media where the content presentation is largely supported by paid advertisements that are added to the web-page content. Typically, advertisements are displayed using portions of code written in, for example, hyper-text mark-up language (HTML) or JavaScript that is inserted into, or otherwise called up by documents also written in HTML and which are sent to a user node for display. A web-page typically contains text and multimedia elements that are intended for display on the user's display device.

One of the most common types of advertising methods is advertising through search engines by bidding on keywords received from users as search terms. Advertisers that win the bid typically are allowed to provide their advertisements early on in the search results. For example, advertisers seeking to show advertising content to people browsing the internet may bid on keywords entered in a Google® search engine. Specifically, an advertiser looking to sell sunglasses may bid on keywords such as “sun,” “glasses,” “sunglasses,” “beach,” “pool,” etc.

Data about all search keywords is used by the advertisers in order to achieve an efficient analysis and research. Such data may help an advertiser determine which keywords are most closely associated with the product or service that the advertiser is attempting to sell and, thus, would indicate which keywords to bid on to most efficiently utilize advertising expenditures.

Occasionally, in correspondence to the keywords, a plurality of multimedia content elements is provided by the search engine. Such multimedia content elements are provided based on metadata generated by the search engines, from the multimedia content elements. For example, when a user enters the keyword “glove” into a search engine, various images, videos, sound clips, etc., that bear metadata indicating an association with gloves may be provided. However, such metadata may not always optimally indicate parameters shown in the multimedia content elements which are not correlative to the advertiser purposes. For example, an advertiser's purpose may include attempting to increase sales of baseball mitts. Images of baseball mitts may include metadata linking the content to the keyword “glove,” so the advertiser may consider bidding on the keyword “glove.” However, many other images or videos featuring gloves may not relate to the advertiser's purpose (e.g., gloves for keeping hands warm) and, thus, may make bidding on the keyword “glove” an inefficient use of advertising resources for that baseball mitt advertiser. Those images or videos that are unrelated to baseball mitts may only have metadata associating them with the word “glove,” and may otherwise lack any indication that they are unrelated to gloves used in baseball.

It would therefore be advantageous to provide a solution that would overcome the deficiencies of the prior art by determining the correlation between keywords and multimedia content elements.

### SUMMARY

Certain embodiments disclosed herein include a method and system for determining the correlation of at least one keyword to a multimedia content element. The method comprises generating at least one signature to a received multimedia content element; searching for at least one potentially correlative keyword respective of the at least one generated signature; and determining the correlation of each of the at least one keywords to the multimedia content element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a system for processing multimedia content displayed on a web-page according to an embodiment.

FIG. 2 is a flowchart describing the process of determining the correlation between a multimedia content element and a plurality of keywords according to an embodiment.

FIG. 3 is a block diagram depicting the basic flow of information in the signature generator system.

FIG. 4 is a diagram showing the flow of patches generation, response vector generation, and signature generation in a large-scale speech-to-text system.

FIG. 5 is a diagram showing the process of determining the correlation between a multimedia content element and a plurality of keywords according to an embodiment.

FIG. 6 is a flowchart illustrating the process of determining correlation based on quality scores according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein allow determining the correlation between at least one keyword and a multimedia content element displayed on a web-page, and analyzing the multimedia content displayed on the web-page accordingly. Based on the analysis results, for one or more multimedia content elements included the web-page, one or more correlating keywords are generated. In one embodiment, in addition to the signatures, the context of the multimedia content element is determined and used in order to determine correlative keywords.

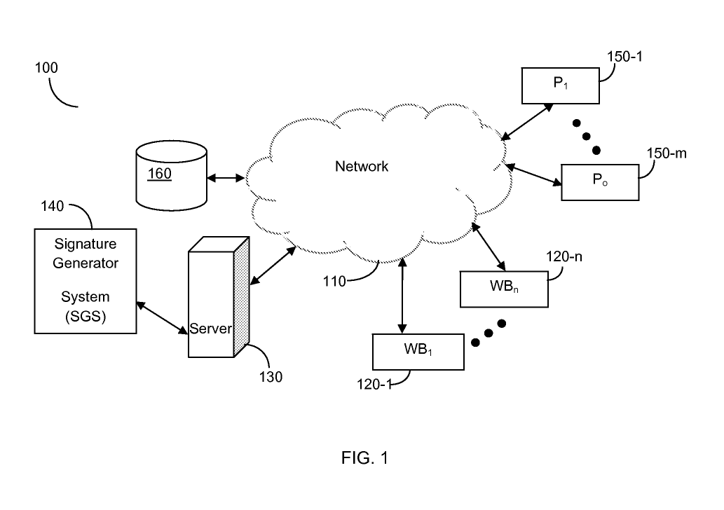

FIG. 1 shows an exemplary and non-limiting schematic diagram of a system 100 for determining correlation between keywords and multimedia content displayed in a web-page in accordance one embodiment. A network 110 is used to communicate between different parts of the system. The network 110 may be the Internet, the world-wide-web (WWW), a local area network (LAN), a wide area network (WAN), a metro area network (MAN), and other networks capable of enabling communication between the elements of the system 100.

Further connected to the network 110 are one or more client applications, such as web browsers (WB) 120-1 through 120-n (collectively referred hereinafter as web browsers 120 or individually as a web browser 120, merely for simplicity purposes). A web browser 120 is executed over a computing device including, for example, personal computers (PCs), personal digital assistants (PDAs), mobile phones, a tablet computer, a wearable computing device, and other kinds of wired and mobile appliances, equipped with browsing, viewing, listening, filtering, and managing capabilities etc., that are enabled as further discussed herein below.

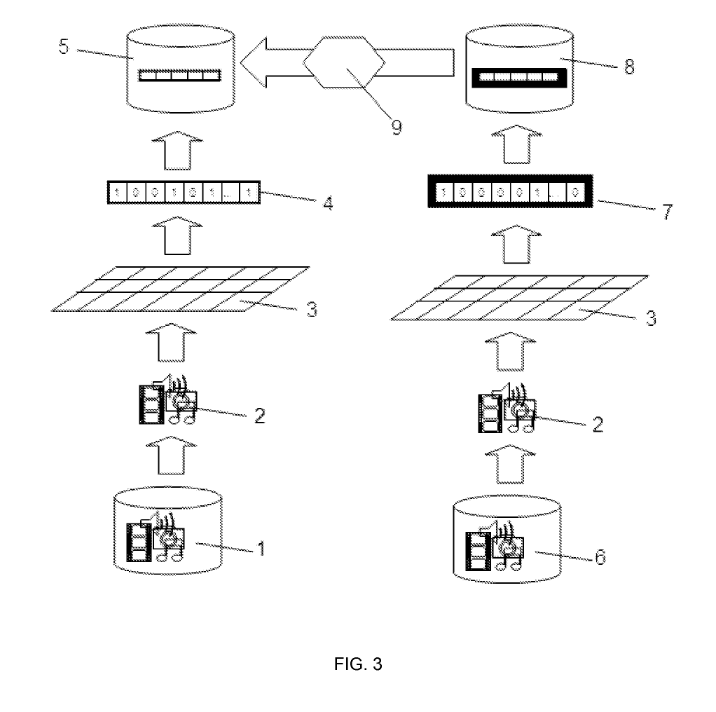

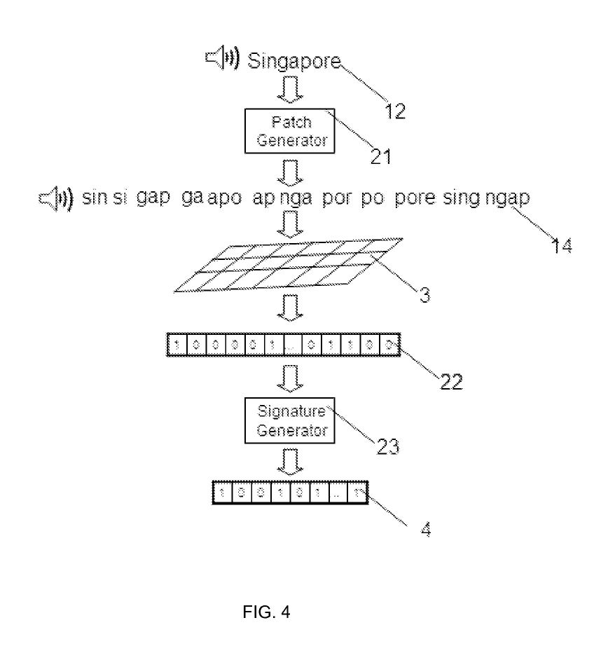

A server 130 is further connected to the network 110 and may provide to a web browser 120 web-pages containing multimedia content, or references therein, such that upon request by a web browser, such multimedia content is provided to the web browser 120. The system 100 also includes a signature generator system (SGS) 140. In one embodiment, the SGS 140 is connected to the server 130. The server 130 is enabled to receive and serve multimedia content and causes the SGS 140 to generate a signature respective of the multimedia content. The process for generating the signatures for multimedia content, is explained in more detail herein below with respect to FIGS. 3 and 4.

It should be noted that each of the server 130 and the SGS 140, typically comprises a processing unit, such as processor (not shown) that is coupled to a memory. The memory contains instructions that can be executed by the processing unit. The server 130 also includes an interface (not shown) to the network 110.

A plurality of ad-serving systems 150-1 through 150-m are also connected to the network 110, each of which is configured to generate and send online multimedia content elements to the server 130. The ad-serving systems 150-1 through 150-m typically receive the content from advertising agencies that set the advertising campaign. In one embodiment, the multimedia content element may be stored in a data warehouse 160 which is connected to the server 130 (either directly or through the network 110) for further use.

According to the embodiments disclosed herein, a user sends a multimedia content element to the server 130 to be analyzed, using a web-browser 120. The request to analyze the multimedia content can be generated and sent by a script executed in the web-page, an agent installed in the web-browser, or by one of the ad-serving systems 150. The request to analyze the multimedia content may include the multimedia content, a URL of a web-page in which the multimedia content appears, a copy of the web-page in which the multimedia content appears. In one embodiment, the request may include multimedia content elements extracted from the web-page. A multimedia content element may include, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof.

The server 130 is configured to analyze the multimedia content elements in the web-page to detect one or more correlative keywords to the multimedia content elements. It should be noted that the server 130 may analyze all or a sub-set of the multimedia content elements contained in the web-page. According to one embodiment, one or more optional keywords are received from either the ad-serving system 150 or the web browser 120 respectively. According to another embodiment, optional keywords are extracted from the data warehouse 160. The SGS 140 is configured to generate for each multimedia content element provided by the server 130 at least one signature. The generated signature(s) may be robust to noise and distribution as discussed below. Then, using the generated signature(s) the server 130 searches the data warehouse 160 for one or more correlative keywords.

As an example, if the signature of an image indicates a Coca Cola® bottle, then “soft drinks” can be potential keywords. According to one embodiment, the context of the multimedia content element may also be determined. The determination of the context of the multimedia content allows performing a contextual match between the context of the keywords and the context of the multimedia content. For example, the correlation of an image of a broken Coca Cola® bottle and the keywords “coca cola happy” will be determined as low based on the image context even although the generated signatures are matched. The determination of the context of the multimedia content is described in co-pending U.S. patent application Ser. No. 13/770,603 (hereinafter the '603 Application) to Raichelgauz, et al., which is assigned to common assignee, and is incorporated hereby by reference for all that it contains.

It should be noted that using signatures for searching of correlative keywords ensures more accurate reorganization of multimedia content than, for example, when using metadata. For instance, in order to provide a matching keyword for a Rum bottle it may be desirable to locate a bottle of a particular kind or brand of Rum. However, in most cases the kind of the bottle would not be part of the metadata associated with the multimedia content (image). Moreover, the bottle shown in an image may be positioned at a different angle from the angles of a specific photograph of the bottle that is available as a search item. The signature generated for that image would enable accurate recognition of the kind of the bottle because the signatures generated for the multimedia content elements, according to the disclosed embodiments, allow for recognition and classification of multimedia elements, such as, content-tracking, video filtering, multimedia taxonomy generation, video fingerprinting, speech-to-text, audio classification, element recognition, video/image search and any other application requiring content-based signatures generation and matching for large content volumes such as, web and other large-scale databases.

In one embodiment, the signatures generated for more than one multimedia content element are clustered. The clustered signatures are used to search for one or more correlative keywords. The one or more selected correlative keywords are retrieved from the data warehouse 160 and uploaded to the web-page on the web browser 120.

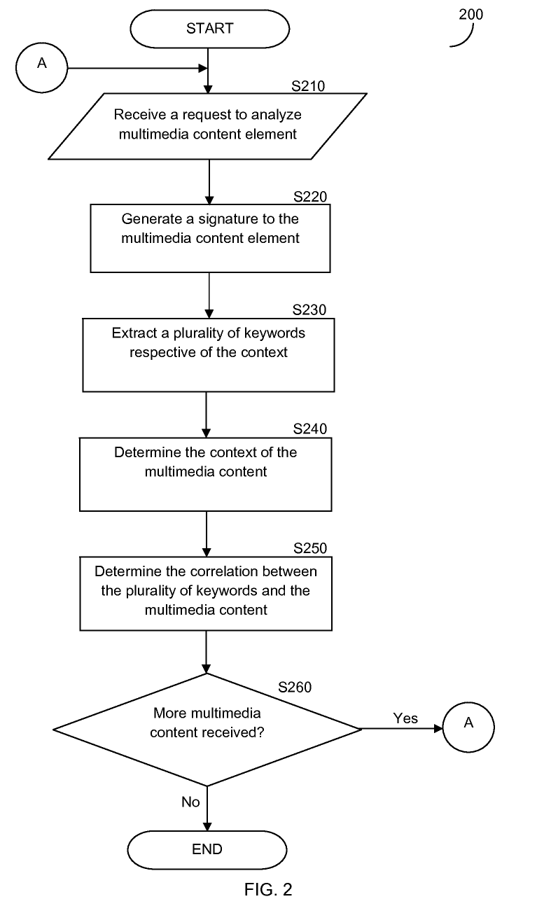

FIG. 2 depicts an exemplary and non-limiting flowchart 200 describing the process of determining the correlation between a multimedia content element and a plurality of keywords according to an embodiment. In S210, a request to analyze at least a multimedia content element is received. In an embodiment, the request is received by the server 130. The request to analyze at least a multimedia content element may be received from an ad-serving system (e.g., a server 150-1), a script running on the uploaded web-page, or an agent (e.g., an add-on) installed in the web-browser. S210 may also include extracting the multimedia content elements for a signature that should be generated. The multimedia content element may be extracted from, for example, a database (e.g., database 160), a web-page, a user input, and the like.

In S220, one or more signatures are generated for the multimedia content element. In an embodiment, a server is configured such that the signatures for the multimedia content element are generated by a signature generator as described below. In S230, a plurality of keywords is extracted respective of the one or more signatures of the multimedia content. In an embodiment, the plurality of keywords is extracted from a data warehouse (e.g., data warehouse 160). In one embodiment, the extraction process includes searching for at least one keyword respective of the signature of the multimedia content. In one embodiment, the extraction of the keywords can be performed by the computational cores that are part of a large scale matching discussed in detail below. In that embodiment, keywords associated with signatures that sufficiently match the signature of the multimedia content may be extracted, wherein sufficiency of matching may be determined based on a predetermined threshold, comparison to other matching results, and the like. According to another embodiment, the keywords are received from either a publisher server 150 or a web browser 120.

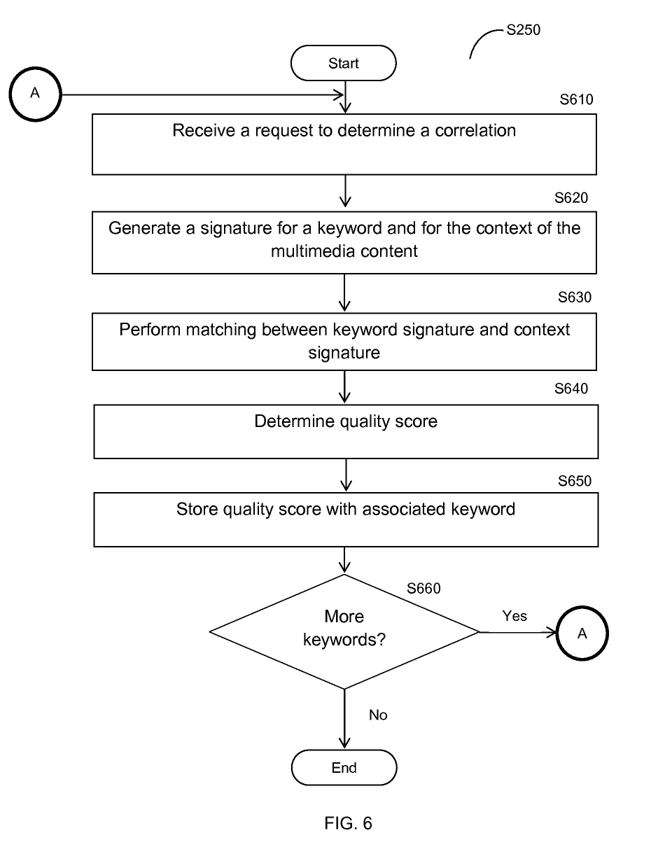

In S240, the context of the multimedia content element is determined by the server 130. Context determination is described in more detail in the '603 Application. In S250, the correlation between the multimedia content and each of the plurality of keywords is determined by the server 130 based on the context of the multimedia content element. According to one embodiment, each keyword from the plurality of keywords receives a quality score based on its correlation to the multimedia content. Assigning quality scores to keywords is discussed further herein below with respect to FIG. 6.

According to another embodiment, the keywords, their associated scores, and the multimedia content are stored in a data warehouse (e.g., the data warehouse 160) for further use. Such quality scores may be used by advertisers for efficiently bidding on multimedia content elements which are provided respective of a keyword through search engines, since such advertisers will typically prefer to bid on multimedia content elements with contexts that more closely match the keywords that are relevant to the advertisers' particular advertising campaigns. According to another embodiment, multimedia content which received a quality score below a certain predetermined threshold will not be displayed corresponding to the respective keyword.

In S260, it is checked whether there are additional requests to analyze multimedia content elements, and if so, execution continues with S210; otherwise, execution terminates.

As a non-limiting example, a user uploads an image of the basketball player Kobe Bryant. The image is then analyzed and one or more signatures are generated respective thereto. Respective of the image signature, a plurality of optional keywords are extracted from the data warehouse, for example: “Kobe Bryant,” “Basketball,” “Los Angeles Lakers,” etc. The context of the image is determined to be Kobe Bryant jumping with a basketball wearing the uniform of the USA National Basketball team. Respective thereto, the keywords “Kobe Bryant” and “Basketball” will receive a high quality score based on the correlation to the context, and the keyword “Los Angeles Lakers” will receive a low quality score, since the context features the uniform of a different basketball team.

FIGS. 3 and 4 illustrate the generation of signatures for the multimedia content elements by the SGS 140 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process will now be described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Cᵢ={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = Π ( Vi - {Th}_{x} )$$

where, [symbol] is a Heaviside step function; wij is a coupling node unit (CNU) between node i and image component j (for example, grayscale value of a certain pixel j); kj is an image component ‘j’ (for example, grayscale value of a certain pixel j); Thx is a constant Threshold value, where x is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (ThS) and Robust Signature (Th_{RS}) are set apart, after optimization, according to at least one or more of the following criteria:

For

Vᵢ>Th_{RS}

1−p(V>Th_{S})−1−(1−ε)^{l}<<1 1

i.e., given that l nodes (cores) constitute a Robust Signature of a certain image I, the probability that not all of these I nodes will belong to the Signature of same, but noisy image, Ĩ is sufficiently low (according to a system's specified accuracy).

p(Vᵢ>Th_{RS})≈l/L 2

i.e., approximately l out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the signature generation is discussed in more detail in the co-pending patent applications of which this patent application is a continuation-in-part, and are hereby incorporated by reference.

A Computational Core generation is a process of definition, selection, and tuning of the parameters of the cores for a certain realization in a specific system and application. The process is based on several design considerations, such as:
(a) The Cores should be designed so as to obtain maximal independence, i.e., the projection from a signal space should generate a maximal pair-wise distance between any two cores' projections into a high-dimensional space.
(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The Cores should be optimally designed with regard to invariance to a set of signal distortions, of interest in relevant applications. Detailed description of the Computational Core generation and the process for configuring such cores is discussed in more detail in U.S. Pat. No. 8,655,801 referenced above.

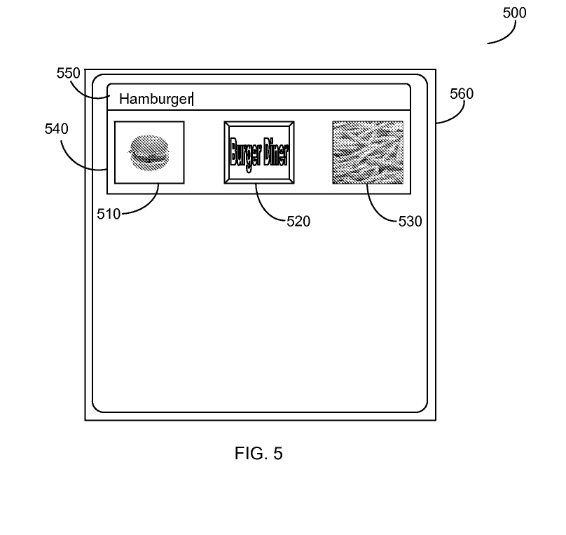

FIG. 5 depicts an exemplary and non-limiting diagram 500 showing the process of determining the correlation of several multimedia content elements to a keyword according to an embodiment. According to this embodiment, the system 100 is used in order to display a plurality of multimedia content elements respective of a keyword based on their quality scores. As further described hereinabove, the quality scores are determined based on the correlation of each image to the keyword. Respective thereto, images of a hamburger sandwich 510, a burger diner 520, fries 530, and a salad (not shown) are provided in a designated display area 540 respective of their correlation to the keyword 550 “hamburger” received as a query by a user device via a user interface 560. The order of the display of the images is determined based on the correlation of each image to the keyword 550. As the image of the hamburger sandwich 510 received the highest score, it is displayed first, followed by the image of the burger diner 520 and the image of the fries 530. The image of the salad will not be displayed within the designated display area 540 as it does not meet the required threshold.

In this example, the image of the salad shared common features with the hamburger of being related to food and containing lettuce, but is otherwise unrelated from the hamburger.

FIG. 6 is an exemplary and non-limiting flowchart S250 illustrating the process of determining correlations between each of a plurality of keywords and a multimedia content based on quality scores according to one embodiment. It should be appreciated that, in various embodiments, correlations for multiple keywords may be determined simultaneously without departing from the scope of the disclosed embodiments.

In S610, a request to determine a correlation is received. In S620, a signature is generated for one of the plurality of keywords. A signature may be also generated for the determined context of the multimedia content. It should be noted that the signatures generated for the multimedia content element (in S220) can be utilized instead of the signature's keywords. The process of signatures generation is discussed further herein above with respect to FIGS. 3 and 4.

In S630, matching is performed between the keyword signature and the context signature. The process of signatures matching is discussed further herein above with respect to FIGS. 3 and 4.

In S640, based on the matching between the keyword signature and the context signature, a quality score is determined. The quality score demonstrates the level of correlation between the keyword and the context, and may be, but is not limited to, a numerical value (e.g., zero through ten, where zero represents no correlation and ten represents identical correlation), a percentage (e.g., 0% through 100%, where 0% represents no correlation and 100% represents identical correlation), and the like. The quality score may be determined to be equal to a level of matching determined as a result of the matching S630, or may be otherwise based on the level of matching (e.g., based on the ratio of matching signature portions to all signature portions included in both signatures).

In S650, the quality score is stored along with its associated keyword for future access. In an embodiment, the quality score is stored in a database (e.g., database 160). In S660, it is checked whether additional correlation of additional keywords from the plurality of keywords must be determined. If so, execution continues with S610; otherwise, execution terminates.

As a non-limiting example, a multimedia content element being analyzed may be an image with a context that is determined to be a man in a suit standing in a courtroom. Additionally, in this example, the keywords “lawyer” and “clothing” may be among the plurality of keywords to be correlated. A signature is generated for each of the context, the keyword “lawyer,” and the keyword “clothing.” Matching is performed between the context signature and the “lawyer” signature, and subsequent matching occurs between the context signature and the “clothing” signature. In this example, matching scores are assigned as percentages ranging from 0% to 100%, wherein 0% represents no matching and 100% represents an identical match.

The signature for the keyword “lawyer” is given a matching score of 90%, since a man standing in a courtroom while wearing a suit has a relatively high likelihood of being a lawyer. The signature for the keyword “clothing” is given a matching score of 10%, since, although clothing is present, the clothing does not appear to be prominently displayed in the image. In this example, the quality score is equal to the matching score. Accordingly, quality scores of 90% and 10% are determined for the keyword “lawyer” and the keyword “clothing,” respectively. These values are stored with their respective keywords in a database. If an advertiser subsequently accesses these values, the advertiser may note that this image would be more effective for promoting legal services than for promoting clothing.

It should be noted that the processes disclosed herein can performed by the server 130. In an embodiment, a user computing device (e.g., a smartphone, a PC computer, a tablet computer, and a wearable computing device, etc.) may be updated to locally perform the correlation between keywords and multimedia content elements.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining the correlation of at least one keyword to a multimedia content element, comprising:
generating at least one signature to a received multimedia content element;
searching for at least one potentially correlative keyword respective of the at least one generated signature; and
determining the correlation of each of the at least one keywords to the multimedia content element.

2. The method of claim 1, wherein the at least one multimedia content element is received from at least one of: an ad-severing system, and a web browser.

3. The method of claim 2, wherein the at least one multimedia content element is received by a web browser using at least one of: a script, and an agent installed in the web browser.

4. The method of claim 1, wherein the received at least one multimedia content element is embedded in a web-page.

5. The method of claim 1, wherein the search for the at least one correlative keyword is made through at least one of: a data warehouse, a plurality of potential keywords received from a web browser, and a plurality of potential keywords received from an ad-serving system.

6. The method of claim 1, further comprises:
determining the context of the at least one multimedia content element;
determining the correlation between the at least one correlative keyword and the at least one multimedia content element based on the context;
storing the correlation between the at least one keyword and the at least one multimedia content in a data warehouse.

7. The method of claim 6, further comprising:
generating a quality score for each of the one or more correlative keywords based on its correlation to the at least one multimedia content element.

8. The method of claim 1, further comprising:
clustering signatures generated for each of the at least one multimedia content element; and
searching for at least one keyword correlative to the cluster of signatures.

9. The method of claim 1, wherein the multimedia content element is at least one of: an image, graphics, a video stream, a video clip, an audio stream, an audio clip, a video frame, a photograph, images of signals, combinations thereof, and portions thereof.

10. A non-transitory computer readable medium having stored thereon instructions for causing one or more processing units to execute the method according to claim 1.

11. A system for determining the correlation of at least one keyword to a multimedia content element, comprising:
an interface to a network for receiving a request to analyze at least one multimedia content element;
a processor; and
a memory, wherein the memory contains instructions that, when executed by the processor, configure the system to:
search for at least one correlative keyword to the at least one multimedia content element respective of its signature; and
determine the correlation of the at least one keyword to the at least one multimedia content element.

12. The system of claim 11, further comprising:
a signature generator system configured to generate signatures for the at least one multimedia content element.

13. The system of claim 11, further comprises:
a database for maintaining keywords correlative to the generated signatures.

14. The system of claim 11, wherein the at least one multimedia content element is received from at least one of: an ad-serving system node, and a web browser.

15. The system of claim 14, wherein the at least one multimedia content element is received by a web browser using at least one of: a script, and an agent installed in the web browser.

16. The system of claim 11, wherein the multimedia content element is embedded in a web-page.

17. The system of claim 14, wherein the search for one of the plurality of correlative keywords is made through at least one of: a data warehouse, a plurality of potential keywords received from a web browser, and a plurality of potential keywords received from ad-serving system.

18. The system of claim 11, the system is further configured to:
determine the context of the at least one multimedia content element;
determine the correlation between the at least one correlative keyword and the at least one multimedia content element based on the context; and
store the correlation between the at least one keyword and the at least one multimedia content in a data warehouse.

19. The system of claim 18, the system is further configured to:
generate a quality score to each of the at least one correlative keyword based on its correlation to the at least one multimedia content element.

20. The system of claim 11, wherein the system is further configured to:
cluster signatures generated for each of the at least one multimedia content element; and
search for at least one keyword in the database correlative to the cluster of signatures.

21. The system of claim 11, wherein the multimedia content element is at least one of: an image, graphics, a video stream, a video clip, an audio stream, an audio clip, a video frame, a photograph, images of signals, combinations thereof, and portions thereof.
